(19) United States
(12) Patent Application Publication
(10) Pub. No.: US 2007/0102342 A1
(43) Pub. Date: May 10, 2007

(54) On-the-fly long-running rotary filtration screen device

(76) Inventor: Ping Ho Lin, Tainan County (TW)

Correspondence Address: Ping Ho Lin, No. 2, Alley 492, Hai Tien Rd. Sec. 2, Tainan City, TW

(21) Appl. No.: 11/267,799

(22) Filed: Nov. 7, 2005

(51) Int. Cl. B01D 33/06; B01D 33/073

(52) U.S. Cl. 210/402

(57) ABSTRACT

The present invention concerns an on-the-fly long-running rotary filtration screen comprising a rotating split-flow bar, a filtration sleeve, filtration screen, a large gear, a small gear, a motor, a stop disc, two square keys, a outlet housing and a residue-removing rod. The main feather of the present invention is to employ the filtration bar to rotate continuously, mix and transport the plastic raw material toward the space formed between the split-flow and the filtration sleeve, thereby allowing the plastic raw material to flow into the conical hole and to be discharged from the funnel-shaped outlet of the outlet housing. When the motor is actuated, the hydraulic cylinder is also actuated with the motor. The action of the hydraulic cylinder causes the round rod to move forward, which in turn causes the filtration bar to move forward to a certain distance and backward to its original position, thereby generating a reciprocating action. Meanwhile, the plastic raw material is being mixed and stirred continuously, the action of transportation causes extraneous matters to be pushed into the space of the residue-removing thread and the guide bar is inserted into the guide bar slot, which is equipped in the residue-removing bar, to cause the residue-removing bar to rotate continuously, the action causes the extraneous matters to be pushed outward, thereby allowing the extraneous matters accumulated inside the space of the residue-removing thread to be discharged from the main housing, thus allowing the filtration device to operate continuously without stopping.

### BACKGROUND OF THE INVENTION

The present invention concerns an on-the-fly long-running rotary filtration screen. More specifically, the present invention relates to an on-the-fly long-running rotary filtration screen, wherein a filtration bar that comprises a rotating splitflow bar and a filtration sleeve is employed to filter away extraneous matters. The motor is actuated, which causes the large gear linked to the small gear to rotate. The hydraulic cylinder is also actuated with the motor. The action of the hydraulic cylinder causes the filtration bar to move forward to a certain distance and backward to its original position, thereby generating a reciprocating action. Meanwhile, the plastic raw material is being mixed and stirred continuously, the action of transportation causes extraneous matters to be pushed into the space of the residue removing thread and to be pushed outward, thereby allowing the extraneous matters accumulated inside the space of the residue-removing thread to be discharged from the main housing so that a cleaner raw material can be obtained with the need to change the filtration screen. Moreover, an on-the-fly long-running rotary filtration device operation can be maintained.

Conventional filtration devices typically involve inserting a filtration screen onto a split-flow bar. However, this design is problematic in that the operating machinery must be stopped periodically in order to remove the extraneous matters collected by the filtration screen, and because this cleaning procedure is time consuming. It interrupts the transport of the raw material and it is uneconomical. As a result, productivity is adversely affected. Moreover, since extraneous matters cannot be removed continuously, a thorough filtration process cannot be realized and the filtered raw material still contains some extraneous matters. The on-the-fly long-running rotary filtration screen device of the present invention is based on a circumferential.

The following merits can be achieved with the design improvement of the present invention:
1. On-the-fly operation: With the filtration device of the present, a guide bar 47 is inserted into the guide bar slot equipped inside the residue removing rod to cause the residue removing rod 12 to rotate continuously, thereby pushing the extraneous matters outward without remaining. Accordingly, the operating machinery can operate continuously without interrupts in the production cycle. Furthermore, the cleaning operation is simple since it is not necessary to stop the operating machinery.
2. Time saving: Since the residue-removing rod can be cleaned without interrupting the feed process, the time required to filter a plastic material can be reduced and the feeding process is not subject to downtime.
3. Thorough residue remove: The lower guide slot 36 allows extraneous matters to flow into the space of the residue removing thread.
4. Long working life: The filtration device of the present invention is completely automatic and does not require disassembly, which is disable from the standpoint of the labor and maintenance costs. Moreover, the problem of the damaging parts and components due conventional filtration devices is alleviated.

### SUMMARY OF THE INVENTION

The present invention that relates to an on-the-fly long-running rotary filtration device comprises a residue removing bar which rotates continuously The action of residue removing bar pushes filtered extraneous matters outward and causes the extraneous matters to be discharged from the main housing without the need to change the filtration screen. Thus, an on-the-fly long-running rotary filtration operation can be maintained.

```
  (1) Main housing
  (2) Split-flow bar
  (3) Filtration sleeve
  (4) Filtration screen
  (5) A large gear
  (6) A small gear
  (7) Motor
  (8) Stop disc
  (9) Square key
(10) Square key
(11) Outlet housing
(12) Residue-removing rod
(13) Round through hole
(14) Intake opening
(15) Funnel-shaped opening
(16) Round hole
(17) Rectangular slot
(18) Rectangular slot
(19) Round rod
(20) Threaded rod
(21) Round through hole
(22) Circular sunk slot
(23) Threaded hole
(24) Threaded hole
(25) Conical hole
(26) Threaded hole
(27) Cylinder
(28) Small round hole
(29) Rod through hole
(30) Rectangular slot
(31) Rectangular slot
(32) Round through hole
(33) Rectangular slot
(34) Rectangular slot
(35) Residue-removing thread
(36) Conduit
(37) Hydraulic cylinder
(38) Round disc
(39) Threaded hole
(40) Threaded hole
(41) Funnel-shaped opening
(42) Screw
(43) Screw
(44) Space
(45) Round rod
(46) Hydraulic cylinder
(47) Guide bar
(48) Guide bar slot
(51) Main housing
(52) Split-flow bar
(53) Filtration Sleeve
(54) Filtration Screen
(55) Residue-removing bar
```

### BRIEF DESCRIPTION OF THE DRAWINGS

FIG. 1 is a dissectional drawing of the filtration device of the previous invention

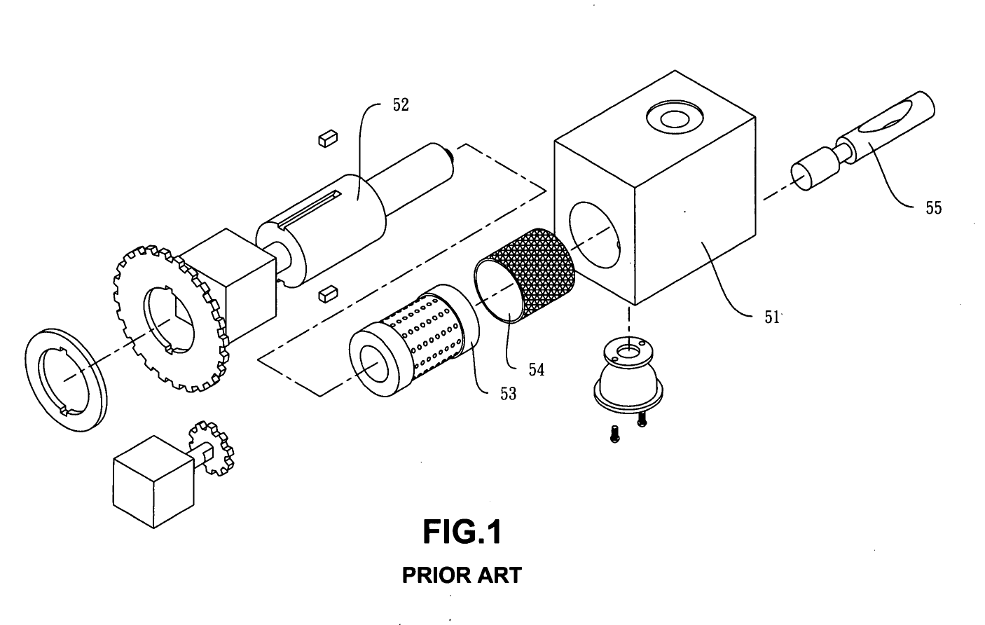

FIG. 2 is a detailed drawing of the residue removing rod of the present invention.

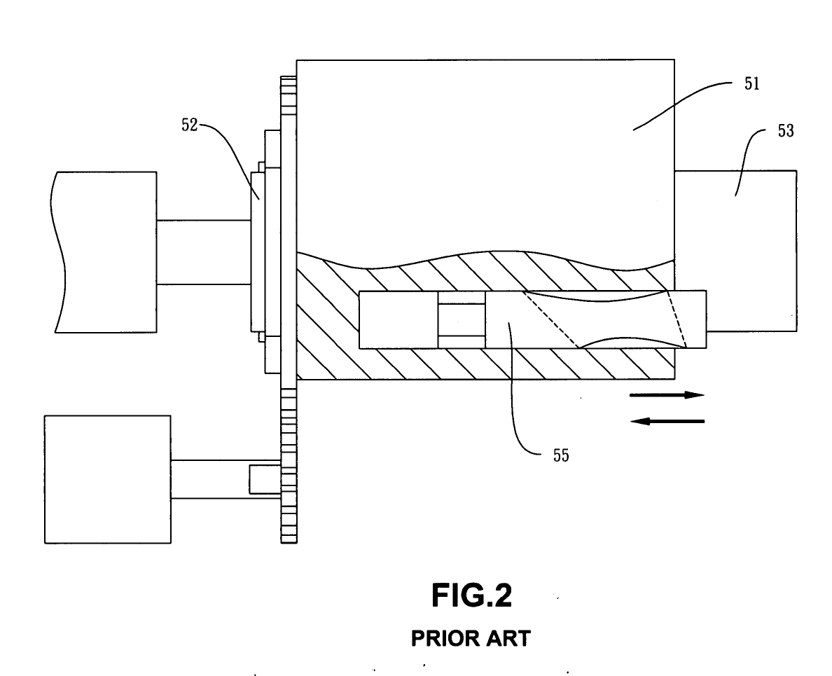

FIG. 3 is a three-dimensional drawing of the filtration device of the previous invention

FIG. 4 is a dissectional drawing of the filtration device of the previous invention

FIG. 5 is a cut-away drawing of the A-A section of the filtration device of the present invention.

FIG. 6 shows the action of the A-A section of the filtration device of the present invention.

FIG. 7 is cut-away drawing of the B-B section of the filtration device of the present invention.

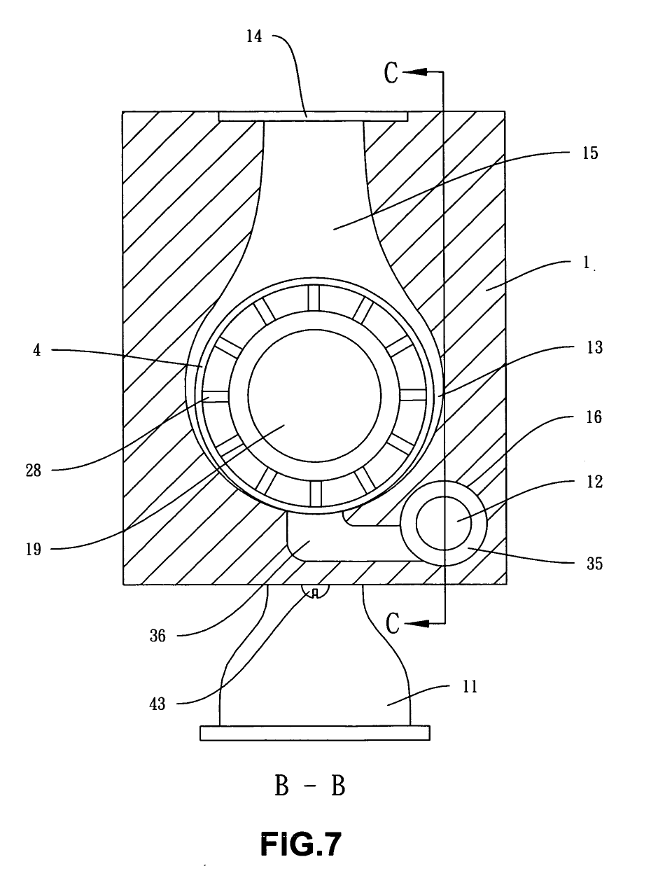

FIG. 8 shows the action of the C-C section of the filtration device of the present invention.

### DETAILED DESCRIPTION OF THE INVENTION

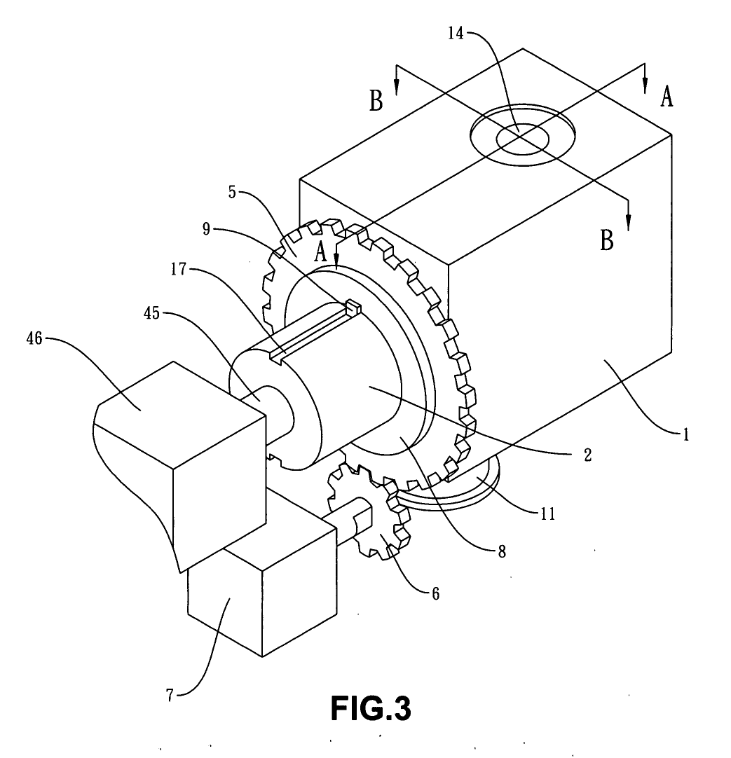

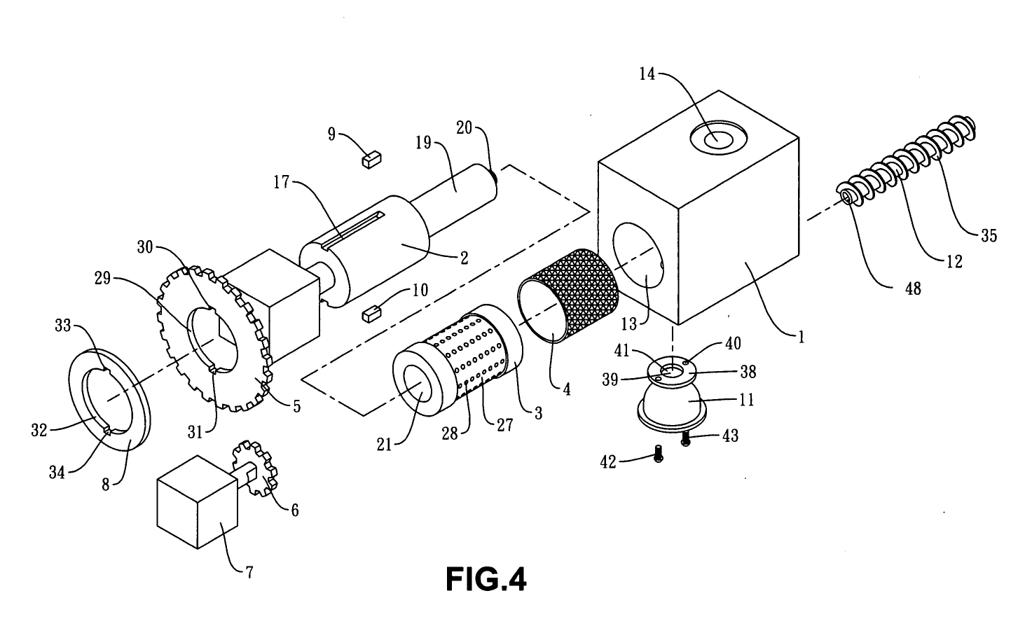

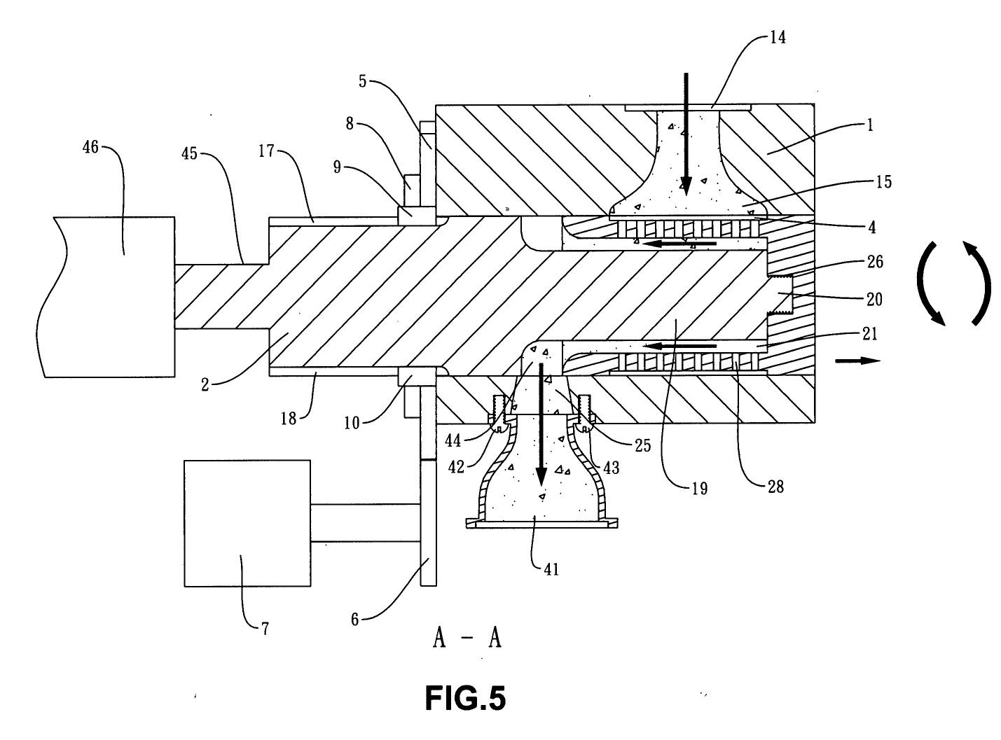

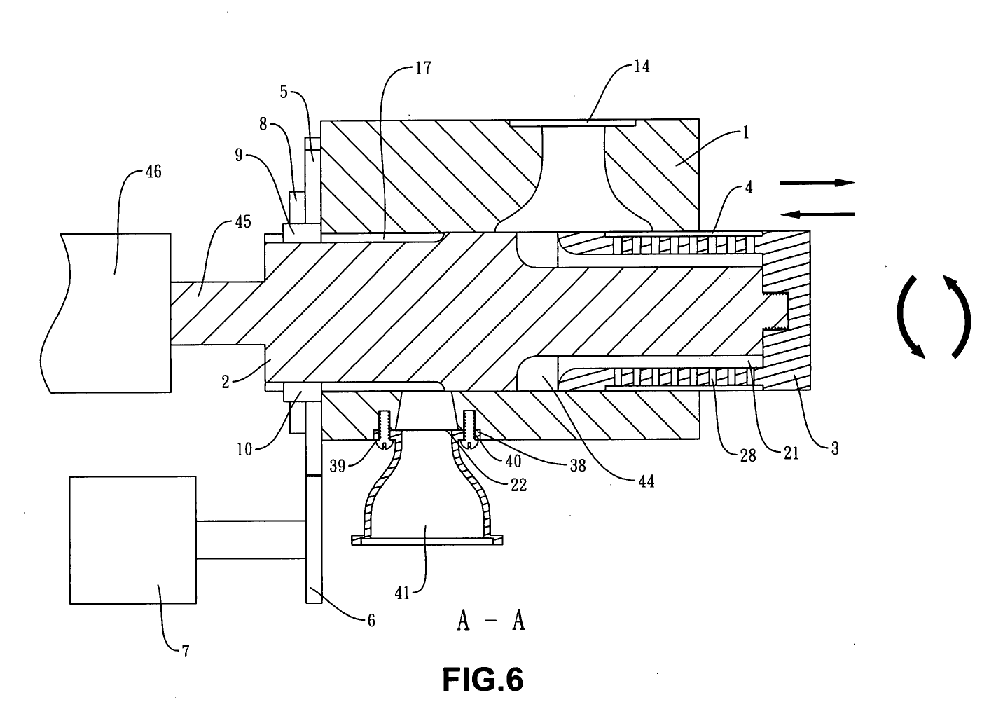

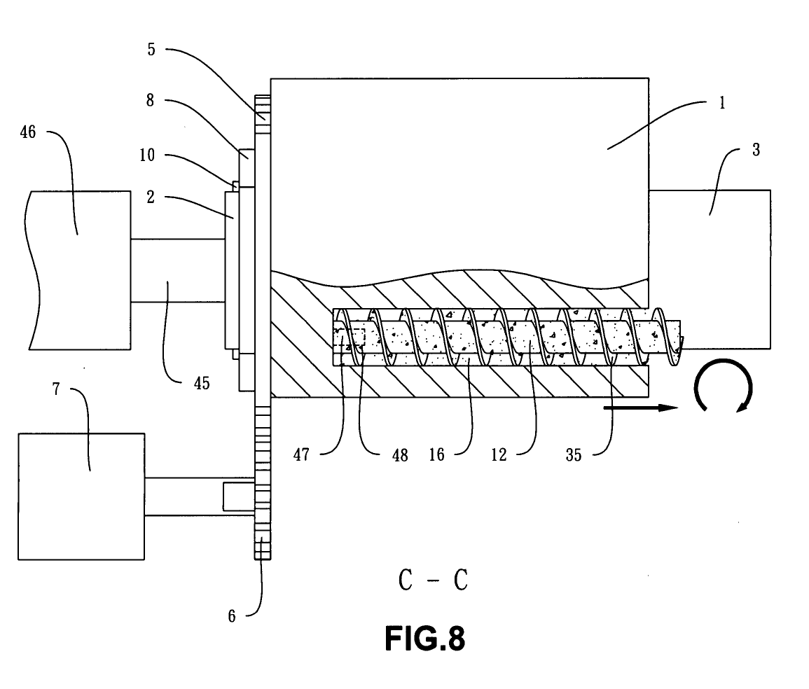

As shows in FIG. 3 and 4, the On-the-fly Long-running rotary Filtration Screen device of the present invention comprises a main housing 1, a split-flow bar 2, a filtration sleeve 3, a filtration screen 4, a large gear 5, a small gear 6, a motor 7, a stop disc 8, two square keys 9 and 10, an outlet housing 11 and a residue removing rod 12. The interior of the main housing is required with a round through hole 13, the upper part is equipped with a perpendicular intake opening 14, the intake opening extends downward and is tapered to form a funnel-shaped opening 15, the funnel-shaped opening 15 is connected to the round through hole 13, the lower side of the round through hole 13 is also equipped with a round hole 16, a conduit 47 connecting the two round holes 16 and 13 is installed between the round 16 and the through hole 13 the round hole 16 doesn't completely piece through the main housing 1, the true bottom of the rear part of the main housing 1, is equipped with a circular sunk slot 22, the circular sunk slot is equipped with two small perpendicular threaded holes 23.24, and the center of the circular sunk slot 22 is equipped with a conical hole 20 connecting with the round through hole 13. The upper of lower portion of the split-flow bar 2 are each equipped with a long rectangular slot 17.18, the left end of the split flow bar 2 is equipped with a round bar 45, the round bar 45 is connected to a hydraulic cylinder 46, the other end of the split-flow bar 2 is equipped with a small round bar 9, with a smaller diameter, and the end of the round bar 19 is equipped with a threaded rod 20, with a small diameter than that of the round rod 19. The center of the filtration sleeve 3 is equipped with a non-piecing threaded round hole, the inner side of the filtration sleeve 3 is equipped with a cylinder 27 is equipped with a number of small round holes 28, and these small round holes are open to the round hole 21. For the large gear 5, the outer rim is toothed and the center is equipped with a round hole 29, and the round hole 29 is equipped with two square slots 30.31 facing each other from opposite sides. The center of the stop disc 8 is equipped with a round hole 32 and the round hole is equipped with two square slots 33.34. As for the residue removing rod 12, its circumference surface is equipped with spiral slice residue removing thread 35, the inner side of the residue removing rod 12 is equipped with a guide bar slot 47, so that guide bar can be inserted inside the guide bar slot 47 (see FIG. 8), the round disc 38 is aligned with two thread holes 39.40 piecing through the round disc 38 and the outlet housing 11 is equipped with a downward funnel-shaped opening 41. In assembling these components, a cylindrical filtration screen 4 is inserted onto the cylinder of the filtration sleeve 3, which is followed by inserting the split-flow bar 2 into the filtration sleeve 3 by screwing the threaded rod 20 into the threaded round hole 26, thereby forming a filtration bar 48. The filtration bar 48 is then inserted into the round through hole 13, which is followed by inserting the large gear 5 (i.e. by means of the round holes 29.) onto the part of the round rod 19 of the split-flow bar 2 of the filtration bar 48 that is outside the main housing 1 and then inserting the square keys 9 and 10 into the spaces formed the two opposing square slots 17.18 of the split-flow bar 2 and the two opposing square slots 30 and 31 of the round hole 29 of the large gear 5. Afterward, the stop disc 8 is placed next to the large gear 5 in a manner that the two square keys 9.10 are housed inside the two square slots 33 and 34 of the stop disc 8. The outlet housing 11 is then installed in the circular sunk slot at the bottom of the main housing 1, the two threaded holes 39.40 of the round disc 38 are aligned with the two thread holes 23.24 on the circular sunk slot 22, and then the residue removing rod 12 is inserted into the round 16 at the lower part of the main housing 1. After assembly, the filtration screen 4 and cylinder 27 are positioned immediately below the funnel-shaped opening 15 on the lower side of the intake opening 14, while a space is formed between the split-flow bar and the filtration sleeve 3 and the gap 44 aligns immediately with the conical 25. In putting the device to work (see FIG. 5.6), the motor is actuated, which causes the small gear 6 to rotate. The rotating small gear 6, which is linked to the large gear 5, in turn causes the large gear 5 to rotate. Since the large gear 5 and the split-flow bar 2 are bound to each other by means of two square keys 9,10, the filtration bar 48 rotates inside the round hole 13 of the main housing. Meanwhile, a plastic raw material is fed from the intake opening 14, and the flow of the plastic raw material generates a pressure that causes it to pass through the filtration screen 4 and the small round holes on the cylinder 27 into the space formed by the split-flow bar and the round hole 21. Meanwhile, the filtration bar, which rotates continuously, mixes and transports the plastic raw material toward the space formed between the split-flow and the filtration sleeve 3, thereby allowing the plastic raw material to flow into the conical hole 25 and to be discharged from the funnel-shaped outlet of the outlet housing 11. The hydraulic cylinder 46 is also actuated with the motor 7. The action of the hydraulic cylinder 46 causes the round rod 45 to move forward as shown in FIG. 6, which in turn causes the filtration bar 48 to move forward to a certain distance and backward to its original position, thereby generating a reciprocating action. Meanwhile, the plastic raw material is being mixed and stirred continuously, the action of transportation causes extraneous matters to be pushed into the space of the residue removing thread 35, the guide bar 47 is inserted into the guide bar slot, which is equipped in the residue removing bar, to cause the residue removing bar to rotate continuously, the action causes the extraneous matters to be pushed outward, thereby allowing the extraneous matters accumulated inside the space of the residue removing thread 35 to be discharged from the main housing 1., thus allowing the filtration device to operate continuously without stopping.

1. An on-the-fly long-running rotary filtration screen device (2) comprising a main housing, said housing including a split-flow bar, and a filtration sleeve are screwed together to form a filtration bar, a filtration screen, a large gear, a small gear, a motor, and a residue removing rod. The motor is actuated, which causes a small gear to rotate. The rotating small gear, which is linked to the large gear, in turn causes the large gear to rotate. Since the large gear and the spit-flow bar are bound to each other by means of two square keys. The filtration bar rotates inside the round hole of the main housing. Meanwhile, a plastic raw material is fed from the intake opening, and the flow of the plastic raw material generates a pressure that causes it to pass through the filtration screen and the small round holes on the cylinder into the space formed by the split-flow bar and the round hole. Meanwhile, the filtration bar, which rotates continuously, mixes and transports the plastic raw material toward the space formed between the split-flow and the filtration sleeve, thereby allowing the plastic raw material to flow into the conical hole and to be discharged from the funnel-shaped outlet of the outlet housing. The hydraulic cylinder is also actuated with the motor. The action of the hydraulic cylinder causes the round rod to move forward, which in turn causes the filtration bar to move forward to a certain distance and backward to its original position, thereby generating a reciprocating action. Meanwhile, the plastic raw material is being mixed and stirred continuously, the action of transportation causes extraneous matters to be pushed into the space of the residue-removing thread, the guide bar is inserted into the guide bar slot, which is equipped in the residue-removing bar, to cause the residue-removing bar to rotate continuously, the action causes the extraneous matters to be pushed outward, thereby allowing the extraneous matters accumulated inside the space of the residue-removing thread to be discharged from the main housing, thus a cleaner raw material can be obtained and allowing the filtration device to operate continuously without stopping.
